(19) United States
(12) Patent Application Publication
(10) Pub. No.: US 2008/0178215 A1
(43) Pub. Date: Jul. 24, 2008

(54) DIGITAL/ANALOG BROADCAST RECEIVER

(75) Inventor: Hiroshi Nishigaki, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/960,455

(22) Filed: Dec. 19, 2007

(30) Foreign Application Priority Data
Dec. 20, 2006 (JP) 2006-342613

(51) Int. Cl. H04N 5/445

(52) U.S. Cl. 725/38

(57) ABSTRACT

The present invention provides a digital/analog broadcast receiver capable of satisfying the needs of a viewer attached to analog broadcasting. When analog broadcasting cannot be received, the viewer is allowed to select whether a search to check if a station of analog broadcasting can be tuned is performed or not. When the viewer selects to perform the search, the search is performed on all of channels of analog broadcasting. When all of the channels cannot be tuned, the viewer is again allowed to select if the search is performed again or the mode is switched to a digital reception mode. When the search is selected again and, as a result of the search, the channels of analog broadcasting cannot be tuned, a message of notifying of the termination of analog broadcasting and a message prompting the viewer to select if the mode is switched to the digital reception mode are displayed on a screen. When the switch to the digital reception mode is selected, tuning of digital broadcasting is executed.

### BACKGROUND OF THE INVENTION

1. Field of the Invention

The present invention relates to a digital/analog broadcast receiver capable of receiving both of digital broadcasting and analog broadcasting.

2. Background Art

In Japan, the terrestrial digital broadcasting has started in 2003, and the analog broadcasting is scheduled to completely stop and to be shifted to digital broadcasting in 2011. By the year 2011, the digital broadcasting and the analog broadcasting are both to be used, and the simulcast system capable of viewing the same program in both of the digital and analog broadcasting is employed. Consequently, a digital/analog broadcast receiver capable of receiving both of the digital and analog broadcasting is provided for the market. Japanese Unexamined Patent Application Publication Nos. 2004-320449, H04-369189, 2004-120475, and 2002-232793 disclose such digital/analog broadcast receivers.

In Japanese Unexamined Patent Application Publication No. 2004-320449, at the end period of analog broadcasting, a message of asking the viewer to shift to a broadcast channel of the digital broadcasting is displayed so that conventional programs can be viewed also after the termination of the analog broadcasting. Alternatively, a broadcast channel of the terrestrial analog broadcasting is automatically changed to a broadcast channel of the terrestrial digital broadcasting, thereby preventing confusion of viewers after the termination of the analog broadcasting.

In Japanese Unexamined Patent Application Publication No. H04-369189, in the case where the reception state of a television broadcast signal in one of broadcasting system deteriorates and becomes improper, the reception state is automatically switched to that of a television broadcast signal in the other broadcasting system, thereby always preventing broadcasting from being lost.

In Japanese Unexamined Patent Application Publication No. 2004-120475, a channel search is executed by a digital tuner. When it is determined that a broadcast signal exists in the same channel as a preset analog broadcast channel, the presetting of the analog channel is cancelled, thereby eliminating a useless presetting. A channel search is also executed by an analog tuner. When a broadcast signal is detected in a channel other than preset channels, the viewer is asked to preset the channel and, further, area-correspondence channel data is updated as necessary. In such a manner, channel presetting adapted to actual broadcasting can be executed by simple operation.

In Japanese Unexamined Patent Application Publication No. 2002-232793, when a designated channel is not tuned and tuning fails in a channel changing operation by the user, a proper channel is tuned automatically, thereby preventing a situation such that nothing is displayed on a screen.

In the case of receiving the analog broadcasting, sometimes, the broadcasting cannot be received in places where the radio wave reception environment is poor such as a mountain-ringed region. In this case, for example, as in Japanese Unexamined Patent Application Publication No. H04-369189, it is possible to switch the analog broadcasting to the digital broadcasting automatically. However, the reason why the analog broadcasting becomes unreceivable may be that tuning is performed when the electric field intensity of radio wave drops by chance, or the antenna is not connected correctly. In addition, some viewers have preference to watch a program in the analog broadcasting rather than the digital broadcasting. Consequently, if the analog broadcasting, when it becomes unable to be tuned, is immediately switched to the digital broadcasting, the needs of some viewers attached to the analog broadcasting cannot be satisfied.

The present invention has been achieved to solve the above-mentioned problem. An object of the invention is to provide a digital/analog broadcast receiver which does not immediately shift to digital broadcasting when analog broadcasting becomes unable to be received, but executes some processes to enable the analog broadcasting to be received and, only when the analog broadcasting cannot be received after the efforts, shifts to the digital broadcasting.

### SUMMARY OF THE INVENTION

The present invention provides a digital/analog broadcast receiver including a digital channel memory that stores channel information of digital broadcasting and an analog channel memory that stores channel information of analog broadcasting, and capable of receiving both digital broadcasting and analog broadcasting. When it is determined that a channel stored in the analog channel memory cannot be tuned in at the time of selecting a channel in an analog reception mode, a message prompting the viewer to select whether a search to check if analog broadcasting stations are tuned in is made or not is displayed on a screen. In the case where it is selected to perform the search to check if analog broadcasting stations are tuned in, a search is performed on all of channels stored in the analog channel memory. When it is determined that all of the channels cannot be tuned in, a message prompting the viewer to select whether a search to check if analog broadcasting stations are tuned in is made again or not, and a message prompting the viewer to select whether the analog reception mode is switched to a digital reception mode or not are displayed on the screen. In the case where it is selected to perform again the search to check if analog broadcasting stations are tuned in, the search on all of the channels stored in the analog channel memory is performed. When a channel which can be tuned in cannot be found after executing the search, a message notifying of the termination of analog broadcasting and a message prompting the viewer to select whether the analog reception mode is switched to the digital reception mode or not are displayed on the screen. In the case where switch to the digital reception mode is selected, tuning of digital broadcasting is executed.

In the present invention, when analog broadcasting cannot be received, the viewer is allowed to determine whether a search to check if analog broadcasting stations are tuned in is made or not. In the case where it is selected to perform the search, a search is performed on all of channels of the analog broadcasting. When all of the channels cannot be tuned in, the viewer is allowed to select whether the search is made again or the analog reception mode is switched to the digital reception mode. When it is selected to perform the search again, the search is performed and, as a result, the channels cannot be tuned in, a message notifying of the termination of analog broadcasting and a message prompting the viewer to select whether the analog reception mode is switched to the digital reception mode or not are displayed on the screen. In the case where switch to the digital reception mode is selected, tuning of digital broadcasting is executed. Consequently, even when analog broadcasting becomes unable to be received, the analog broadcasting does not immediately shift to the digital broadcasting, but some processes to enable the analog broadcasting to be received are executed. Only when the analog broadcasting cannot be received after the efforts, the analog broadcasting shifts to the digital broadcasting. Therefore, the needs of the viewer attached to the analog broadcasting can be satisfied.

In the present invention, when tuning of the digital broadcast channels is performed and, as a result, it is determined that a channel cannot be tuned in, a search may be performed on all of channels stored in the digital channel memory. When it is determined that all of the channels cannot be tuned in, a message notifying of switching to the analog reception mode may be displayed on the screen, and the digital reception mode may be cancelled. According to this, when all of the channels in the digital broadcasting cannot be tuned in, the digital reception mode is cancelled and can be automatically switched to the analog reception mode.

In the present invention, preferably, a message prompting the viewer to check whether an antenna is correctly connected or not is also displayed in the case where it is determined that a channel cannot be tuned in at the time of selecting a channel in the analog reception mode, or in the case where it is determined that a channel cannot be tuned in by a search of checking whether broadcasting is received or not. When the connection of the antenna is poor, by correctly connecting the antenna, analog broadcasting becomes receivable.

In the present invention, preferably, the search on all of channels stored in the analog channel memory is repeated a predetermined number of times when the search of checking whether broadcasting is received or not is selected. By repeating the search the predetermined number of times, the possibility of receiving the analog broadcasting can be increased.

According to the prevent invention, when analog broadcasting becomes unable to be received, the viewer is allowed to have options to execute some processes for enabling the analog broadcasting to be received, and only when the analog broadcasting cannot be received after the efforts, the analog broadcasting is shifted to the digital broadcasting. Thus, the digital/analog broadcast receiver capable of satisfying the needs of the viewer attached to the analog broadcasting can be provided.

### BRIEF DESCRIPTION OF THE DRAWINGS

FIG. 1 is a block diagram of a television receiver according to an embodiment of the present invention;

FIG. 2A is a flowchart showing operations of the television receiver;

FIG. 2B is a flowchart showing operations of the television receiver; and

FIGS. 3A to 3D show examples of messages displayed on a monitor.

### DETAILED DESCRIPTION OF PREFERRED EMBODIMENTS OF THE INVENTION

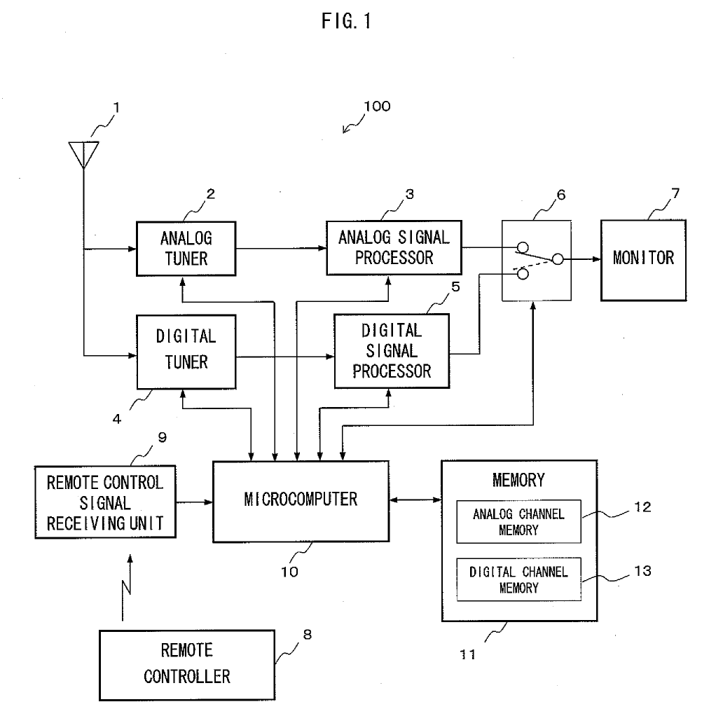

An embodiment of the present invention will be described hereinbelow with reference to the drawings. FIG. 1 is a block diagram of a television receiver 100 capable of receiving both of analog broadcasting and digital broadcasting according to the embodiment of the invention.

The television receiver 100 includes an antenna 1 for receiving airwaves, an analog tuner 2 for selecting an analog broadcast channel, an analog signal processor 3 for processing a signal of a channel selected by the analog tuner 2, a digital tuner 4 for selecting a digital broadcast channel, a digital signal processor 5 for processing a signal of the channel selected by the digital tuner 4. Although two tuners 2 and 4 for analog and digital broadcasting are provided in the embodiment, one tuner for analog and digital broadcasting may be provided. The television receiver 100 also includes a switch 6 for switching between analog broadcasting and digital broadcasting, a monitor 7 for displaying a video image on the basis of an output signal from the analog signal processor 3 or the digital signal processor 5. In FIG. 1, a sound block and a deflection block are not shown.

The television receiver 100 further includes a remote controller 8 operated to make the receiver perform predetermined operation, a remote control signal receiving unit 9 for receiving a signal transmitted from the remote controller 8, a microcomputer 10 as a component of a control unit and controls the analog tuner 2, the analog signal processor 3, the digital tuner 4, the digital signal processor 5, and the switch 6. The television receiver 100 further includes a memory 11 as a component of a storage unit. The memory 11 has an analog channel memory 12 storing analog broadcast channel information and a digital channel memory 13 storing digital broadcast channel information. The channel memories 12 and 13 may be independent memories or may be constructed as a single memory. The analog channel memory 12 stores channel numbers of analog broadcast in correspondence with button numbers of the remote controller 8. The digital channel memory 13 stores channel numbers of digital broadcast in correspondence with button numbers of the remote controller 8.

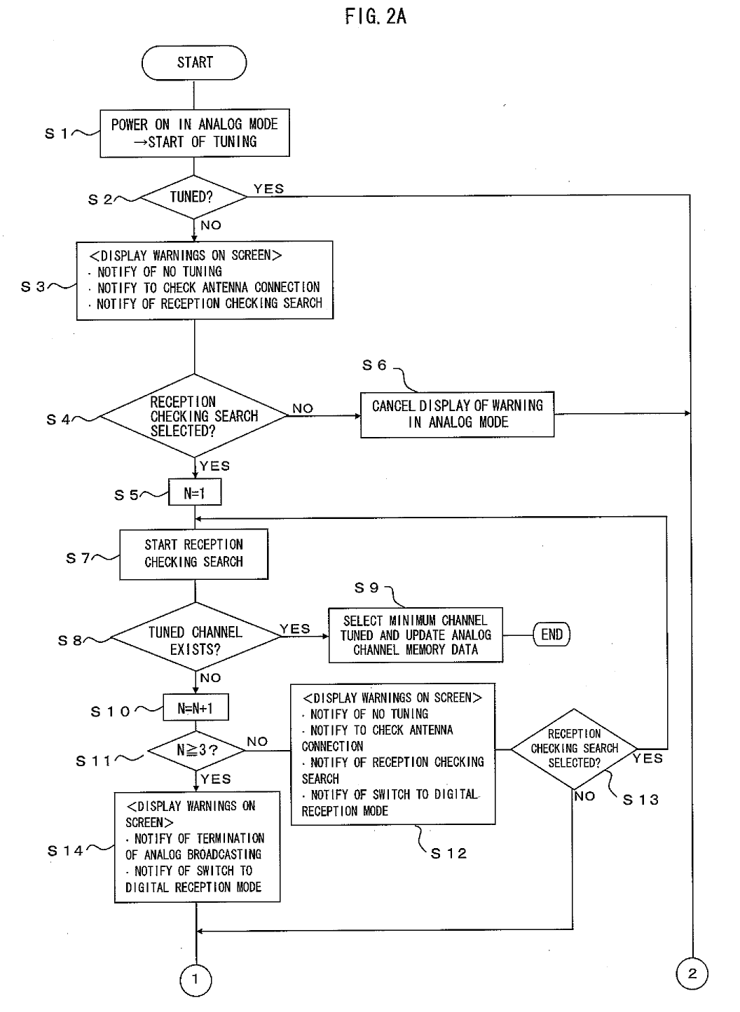

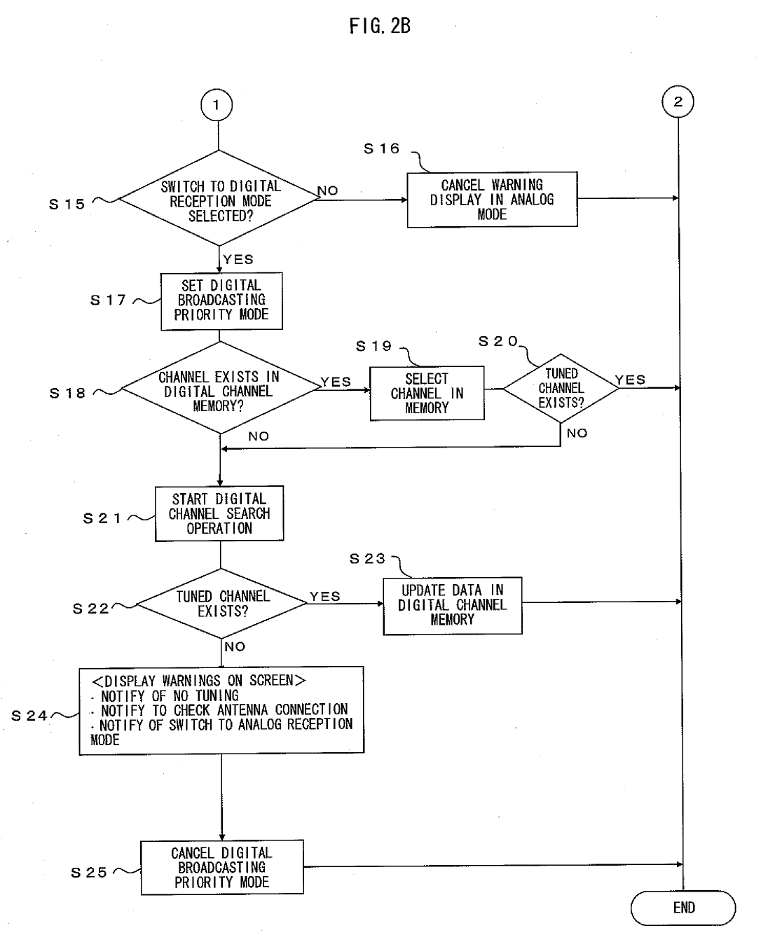

FIGS. 2A and 2B are flowcharts showing operations of the television receiver 100. Referring to the flowcharts, the operations of the television receiver 100 will be described below. In step S1, the remote controller 8 is operated to turn on the power supply of the television receiver 100, sets an analog reception mode as the broadcast mode, and starts tuning. In step S2, whether there is a tuned station or not is determined on the basis of a reception state. When the reception state is normal, it is determined that there is a tuned station (YES in step S2) and normal receiving operation is performed without performing the processes in step S3 and subsequent steps. On the other hand, when it is determined that no signal cannot be received although the selected channel is a channel stored in the analog channel memory 12, it is determined that there is no tuned station (NO in step S2), and the program advances to step S3.

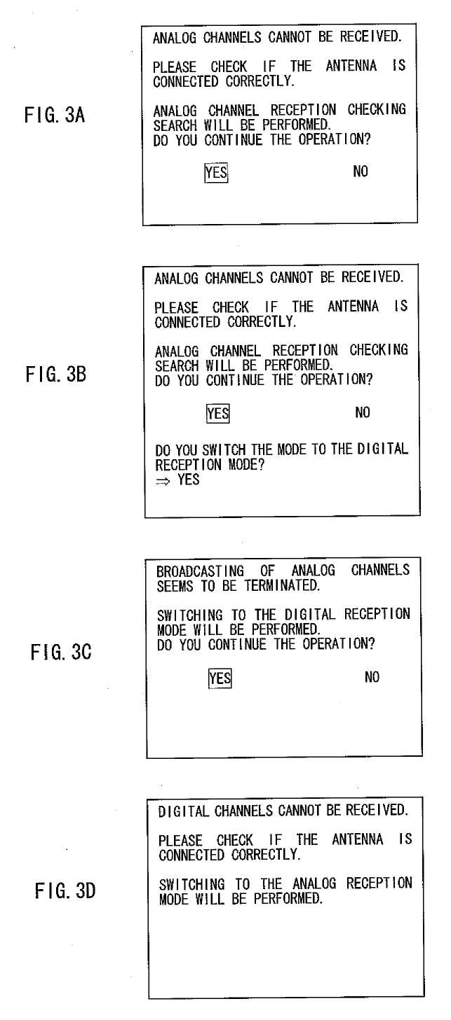

In step S3, messages as shown in FIG. 3A are displayed on the screen of the monitor 7. Shown on the screen area message for notifying of the state where an analog channel cannot be received (the channel is out-of-tuned channel), a message prompting the viewer to check whether the antenna 1 is correctly connected or not, and a message prompting the viewer to select whether a search to check if a channel of an analog broadcast is tuned or not. In the case of performing the search to check whether a channel is tuned or not, “YES” is selected. In the case where the search to check whether a channel is tuned or not is not performed, “NO” is selected. When “YES” is selected (YES in step S4), the program advances to step S5 where a counter value N is set to 1 (N=1). When “NO” is selected (NO in step S4), the program advances to step S6 where a warning display on the screen of FIG. 3A is cancelled while maintaining the analog reception mode as the reception mode.

After the counter value N is set to 1 in step S5, the program advances to step S7 where the search to check whether a channel is tuned or not is executed on all of channels stored in the analog channel memory 12. As a result of the search, whether there is a channel which can be tuned (tuned channel) or not is determined (step S8). When there is a tunable channel (YES in step S8), the tuned channel of the smallest number is selected and data of the analog channel memory 12 is updated (step S9). On the other hand, when any channel cannot be tuned (NO in step S8), the program advances to step S10 where the counter value N is incremented (N=N+1) (in this case, N=2). In the following step S11, whether the counter value N is greater than or equal to 3 (N≧3) or not is determined. When not N≧3 (NO in step S11), the program advances to step S12. When N≧3 (YES in step S11), it is determined that a tunable channel cannot be found even after performing the search for three times, the program advances to step S14.

In step S12, messages as shown in FIG. 3B are displayed on the screen on the monitor 7. Shown on the screen area message for notifying of the state where an analog channel cannot be received (the channel is out-of-tuned channel), a message prompting the viewer to check whether the antenna 1 is correctly connected or not, a message prompting the viewer to select whether a search to check if a channel of an analog broadcast is tuned or not, and a message prompting the viewer to switch to the digital reception mode or not. In the case of performing the search to check whether a channel is tuned or not, “YES” is selected. In the case where the search to check whether a channel is tuned or not is not performed, “NO” is selected. In the case where the mode is switched to the digital reception mode, “YES” is selected. When “YES” is selected for the search to check whether a channel is tuned or not (YES in step S13), the step S7 is executed. When “NO” is selected (NO in step S13), the program advances to step S15.

In step S14, messages as shown in FIG. 3C are displayed on the screen of the monitor 7. On the screen, a message notifying of the termination of analog broadcast and a message prompting the viewer to select whether the mode is switched to the digital reception mode or not are displayed. In the case of switching the mode to the digital reception mode, “YES” is selected. In the case where the mode is not switched to the digital reception mode, “NO” is selected.

In the screen of FIG. 3B or FIG. 3C, when “YES” is selected for switch to the digital reception mode 3C (YES in step S15), the program advances to step S17. When “NO” is selected (NO in step S15), warning display on the screen is cancelled while maintaining the analog reception mode as the reception mode in step S16.

In step S17, the reception mode is set to a digital broadcasting priority mode. In the digital broadcasting priority mode, when the power of the television receiver 100 is on, the reception mode is forcedly set to the digital reception mode. Also, shifting from the digital reception mode to the analog reception mode is regulated. For example, shifting to the analog reception mode can be made only by pressing a broadcast switch key of the remote controller 8 for predetermined time or longer.

In step S18, whether there is a digital broadcast channel in the digital channel memory 13 or not is determined. When there is a digital broadcast channel (YES in step S18), the program advances to step S19 and a channel is selected. When a tunable channel (tuned channel) is selected (YES in step S20), normal receiving operation is performed without performing processes in step S21 and subsequent steps. On the other hand, in the case of an unreceivable channel (out-of-tuned channel) (NO in step S20), the program advances to step S21 where a search is performed on all of channels stored in the digital channel memory 13 to determine whether a channel which can be tuned exists or not (step S22). As a result, when there is a channel which can be tuned (YES in step S22), data in the digital channel memory 13 is updated (step S23), and normal receiving operation is performed. When it is determined that all of channels cannot be tuned (NO in step S22), the program advances to step S24.

In step S24, messages as shown in FIG. 3D are displayed on the screen of the monitor 7. On the screen, a message notifying of the state where a digital channel cannot be received (the channel is out-of-tuned channel), a message prompting the viewer to check whether the antenna 1 is connected correctly or not, and a message of switching to the analog reception mode are displayed. After displaying these warnings, the digital broadcasting priority mode is cancelled (step S25), and the reception mode is switched to the analog reception mode.

As described above, in the foregoing embodiment, in the case where analog broadcasting cannot be received, the viewer is allowed to select whether a search for checking if an analog broadcast station is tuned or not. When the selection is performed, the search is performed on all of analog broadcast channels. In the case where all of the channels cannot be tuned, the viewer is allowed to select either executing the search again or switching to the digital reception mode. When re-execution of the search is selected and, as a result of the search, no broadcasting can be received, a message notifying of the termination of analog broadcasting and a message of prompting the viewer to select whether the mode is switched to the digital reception mode or not are displayed on the screen. When switching to the digital reception mode is selected, selection of a digital broadcast channel is executed. Consequently, even in the case where analog broadcasting cannot be received, the analog broadcasting does not immediately shift to the digital broadcasting, but some processes for enabling the analog broadcasting to be received are executed. Only when the analog broadcasting cannot be received after the efforts, the analog broadcasting shifts to the digital broadcasting. Therefore, the needs of the viewer attached to the analog broadcasting can be satisfied.

In the embodiment, when selection of a digital broadcast station is executed and it is determined that broadcasting cannot be received, a search is performed on all of channels stored in the digital channel memory. When it is determined that all of channels cannot be tuned, a message notifying of switching to the analog reception mode is displayed on the screen, and the digital reception mode is cancelled. Consequently, in the case where all of digital broadcast channels cannot be received, the digital reception mode is cancelled and can be automatically switched to the analog reception mode.

In the embodiment, in the case where the analog reception mode is selected and it is determined that broadcasting cannot be received, or in the case where it is determined that broadcasting cannot be received in a search for checking whether broadcasting is received or not, a message prompting the viewer to check whether the antenna 1 is correctly connected or not is also displayed. Therefore, when the viewer checks the connection of the antenna 1 and connection of the antenna 1 is poor, by correctly connecting the antenna 1, analog broadcasting can be received.

Further, in the embodiment, when a search for checking whether broadcasting is received or not is selected, the search on all of channels stored in the analog channel memory 12 is repeated predetermined number of times (three times in the embodiment). Thus, the possibility of reception of analog broadcasting can be increased.

Preferably, in checking of the reception of analog broadcasting, the determining whether analog broadcasting can be normally received or not is performed, for examples under two conditions of whether the number of pulses of a synchronous signal in a composite signal is equal to or larger than predetermined number within predetermined time or not and whether a video signal is synchronized with a counter for generating a frequency of a deflection system. According to this, an analog broadcasting reception state can be determined more accurately. However, such conditions are not essential in the present invention. The reception state of analog broadcasting can be determined by one of the conditions.

What is claimed is:

1. A digital/analog broadcast receiver including a digital channel memory that stores channel information of digital broadcasting and an analog channel memory that stores channel information of analog broadcasting, and capable of receiving both digital broadcasting and analog broadcasting,
wherein when it is determined that a channel stored in the analog channel memory cannot be tuned in at the time of selecting a channel in an analog reception mode, a message prompting the viewer to select whether a search to check if analog broadcasting stations are tuned in is made or not is displayed on a screen,
in the case where it is selected to perform the search to check if analog broadcasting stations are tuned in, a search is performed on all of channels stored in the analog channel memory, and when it is determined that all of the channels cannot be tuned in, a message prompting the viewer to select whether a search to check if analog broadcasting stations are tuned in is made again or not, and a message prompting the viewer to select whether the analog reception mode is switched to a digital reception mode or not are displayed on the screen,
in the case where it is selected to perform again the search to check if analog broadcasting stations are tuned in, the search on all of the channels stored in the analog channel memory is performed, and when a channel which can be tuned in cannot be found after executing the search, a message notifying of the termination of analog broadcasting and a message prompting the viewer to select whether the analog reception mode is switched to the digital reception mode or not are displayed on the screen, and
in the case where switch to the digital reception mode is selected, tuning of a digital broadcasting channel is executed.

2. The digital/analog broadcast receiver according to claim 1, wherein when tuning of the digital broadcast channels is performed and, as a result, it is determined that a channel cannot be tuned in, a search is performed on all of channels stored in the digital channel memory, and when it is determined that all of the channels cannot be tuned in, a message notifying of switching to the analog reception mode is displayed on the screen, and the digital reception mode is cancelled.

3. A digital/analog broadcast receiver including a digital channel memory that stores channel information of digital broadcasting and an analog channel memory that stores channel information of analog broadcasting, and capable of receiving both digital broadcasting and analog broadcasting,
wherein when it is determined that a channel stored in the analog channel memory cannot be tuned in at the time of selecting a channel in an analog reception mode, it is displayed on a screen that the channel is an out-of-tuned channel, and a message prompting the viewer to check whether an antenna is correctly connected or not and a message prompting the viewer to select whether a search to check if analog broadcasting stations are tuned in is made or not are displayed on the screen,
in the case where it is selected to perform the search to check if analog broadcasting stations are tuned in, a search is performed on all of channels stored in the analog channel memory, and when it is determined that all of the channels cannot be tuned in, a message prompting the viewer to check whether an antenna is correctly connected or not, a message prompting the viewer to select whether a search to check if analog broadcasting stations are tuned in is made again or not, and a message prompting the viewer to select whether the analog reception mode is switched to a digital reception mode or not are displayed on the screen,
in the case where it is selected to perform again the search to check if analog broadcasting stations are tuned in, the search on all of the channels stored in the analog channel memory is repeated a predetermined number of times, and when a channel which can be tuned in cannot be found after executing the search the predetermined number of times, a message notifying of the termination of analog broadcasting and a message prompting the viewer to select whether the analog reception mode is switched to the digital reception mode or not are displayed on the screen,
in the case where switch to the digital reception mode is selected, a digital broadcasting priority mode of placing priority on reception of digital broadcasting is set to execute selection of a digital broadcasting channel, and when it is determined that, as a result of channel selection, a channel cannot be tuned in, a search is performed on all of channels stored in the digital channel memory, and when it is determined that all of the channels cannot be tuned in, a message prompting the viewer to check whether an antenna is correctly connected or not and a message notifying the viewer of switching the digital reception mode to the analog reception mode are displayed on the screen, and the digital broadcasting priority mode is cancelled.
